(19) United States
(12) Patent Application Publication
(10) Pub. No.: US 2008/0274319 A1
(43) Pub. Date: Nov. 6, 2008

(54) Composite Article and Method of Manufacturing Same

(76) Inventors: Ebise Mualla Berksoy, Edmonton (CA); David Slaback, St. Albert (CA)

Correspondence Address: STITES & HARBISON PLLC, 401 COMMERCE STREET, SUITE 800, NASHVILLE, TN, 37219, US

(21) Appl. No.: 11/814,600

(22) PCT Filed: Feb. 7, 2006
(86) PCT No.: PCT/CA2006/000162

§ 371 Date: Mar. 19, 2008

(30) Foreign Application Priority Data
Feb. 7, 2005 (CA) 2495596

(51) Int. Cl. B31C 13/00; B32B 1/08; B05D 3/02

(52) U.S. Cl. 428/36.91; 427/385.5; 156/184

(57) ABSTRACT

There is provided a multi-layered composite article having an inner core of a first composite material and one or more than one outer layers of a second composite material, the second composite material comprising an aliphatic isocyanate polyurethane overlaying the inner core. A method of manufacturing such a composite article is also provided. The method comprises providing a core comprising a reinforcement impregnated with a first resin; mixing an aliphatic isocyanate component and a polyol component to produce a reaction mixture; impregnating a second reinforcement with the reaction mixture to produce an impregnated reinforcement; applying the impregnated reinforcement over an outside surface of the core; and allowing the reaction mixture to set to produce a composite article with one or more than one outer layers of aliphatic isocyanate composite material. The concentration of aliphatic isocyanate in the second composite material or in the reaction mixture is greater than the concentration of aliphatic isocyanate in the first resin or first composite material.

### FIELD OF INVENTION

The present invention relates generally to a composite article and a method of manufacturing such a composite article.

### BACKGROUND OF THE INVENTION

Polyurethane resins are a family of resins that contain a significant number of urethane linkages within its molecular chains. Polyurethane resins are produced by reacting a diisocyanate with an organic compound containing two or more active hydrogen atoms, such as polyols, in predetermined proportions, which react under the influence of heat or certain catalysts to form a polymer resulting in a thermosetting material. A composite article may be produced by impregnating reinforcement, such as glass or carbon fiber, with a polyurethane resin and allowing the resin to react to form a thermosetting composite material using applications known in the art, such as pultrusion, resin injection molding, filament winding, resin transfer molding, and hand lay-up forming applications and the like.

Filament winding is a well known process for the production of composites. In a typical filament winding operation, as disclosed in US 2005/0038222 (which is incorporated herein by reference), a continuous filament of reinforcing material, such as glass fiber, is passed through a liquid resin bath and then wound around a mandrel in order to form a hollow cylindrical object, such as a utility pole. The resin is typically cured by application of heat and/or radiation in order to form the final composite shaped article.

Aromatic polyisocyanate is most widely used in polyurethane resins to manufacture composite articles, due to its strength properties and economic value. The resulting aromatic isocyanate composite material however, is prone to turn yellow on exposure to UV radiation. The color integrity of an aromatic isocyanate composite material quickly diminishes and eventually the resin property of the composite will be weakened after prolonged UV exposure and weathering. Therefore, polyurethane composite articles, especially those utilized in the outdoor environment that are exposed to prolonged periods of UV radiation and other weathering (such as, but not limited to utility poles) need extra protection require extra protection.

Various attempts have been made to maintain the color and integrity of aromatic isocyanate based polyurethane composite articles, for example, by brush painting, spray painting and roller painting the articles with various paint types that are typically resistant to UV radiation. However, these attempts have found little acceptance in view of the expense, technical difficulties and questionable durability of these paints, especially when the polyurethane composite articles are large infrastructure products such as utility poles.

U.S. Pat. No. 6,420,493 (which is incorporated herein by reference) describes the use of volatile organic compound (VOC) free polyurethane composite resins for composite materials. Although a VOC free aliphatic polyisocyanate has superior resistance to chemicals and ultra violet (UV) rays, it is typically much more expensive than a VOC free aromatic polyisocyanate. It is therefore taught in U.S. Pat. No. 6,420,493, that in order to obtain a balance between physical properties and cost a polyisocyanate component comprising a homogeneous blend of at least 15% by weight of an aliphatic polyisocyanate with the remainder being an aromatic polyisocyanate is used in the resin. There remains a need for a composite article with improved UV and scratch resistance and for a method of manufacturing such an article.

### SUMMARY OF THE INVENTION

The present invention relates to a composite article and a method of manufacturing such a composite article.

It is an object to provide a polyurethane composite articles and a method of manufacturing such composite articles.

According to the present invention, there is provided a composite article comprising:
an inner core comprising a first composite material; and
one or more than one outer layers comprising a second composite material overlaying the inner core, the second composite material comprising an aliphatic isocyanate polyurethane;
   wherein the concentration of aliphatic isocyanate in the second composite material is greater than the concentration of aliphatic isocyanate in the first composite material.

The present invention pertains to a composite article as just defined wherein the first composite material may comprise a resin with no aliphatic isocyanate therein. The first composite material may comprise from about 20 to about 85% by weight, or any amount therebetween, of a reinforcement and from about 15 to about 80% by weight, or any amount therebetween of a polyurethane resin. The polyurethane resin of the first composite material may comprise from about 20 to about 80% by weight, or any amount therebetween, of an aromatic polyisocyanate and from about 20 to about 80% by weight, or any amount therebetween, of a polyol. Other polyisocyanates may be present in the polyurethane resin of the first composite material, for example, the polyurethane resin may comprise from about 0% to about 40% by weight, or any amount therebetween, of an aliphatic polyisocyanate, provided that the amount of aliphatic isocyanate in the second composite material is greater than the amount of aliphatic isocyanate in the first composite material. The polyurethane resin of the first composite material may have a OH/NCO weight ratio from about 0.1:1 to about 5:1 (preferably from about 0.4:1 to about 1.5:1), or any amount therebetween. The second composite material may comprise from about 20 to about 85% by weight, or any amount therebetween, of a second reinforcement and from about 15 to about 80% by weight, or any amount therebetween of an aliphatic isocyanate polyurethane resin. The aliphatic isocyanate polyurethane resin of the second composite material may comprise from about 20 to about 80% by weight, or any amount therebetween, of an aliphatic polyisocyanate and from about 20 to about 80% by weight, or any amount therebetween, of a polyol. Other polyisocyanates may be present in the aliphatic isocyanate polyurethane resin of the second composite material, for example, the aliphatic isocyanate polyurethane resin may comprise from about 0% to about 40% by weight, or any amount therebetween, of an aromatic polyisocyanate, provided that the amount of aliphatic isocyanate in the aliphatic isocyanate polyurethane resin of the second composite material is greater than the amount of aliphatic isocyanate in the polyurethane resin of the first composite material. The aliphatic isocyanate polyurethane resin of the second composite material may have a OH/NCO weight ratio from about 0.1:1 to about 5:1 (preferably from about 0.4:1 to about 1.5:1), or any amount therebetween.

The present invention pertains to a composite article as just defined wherein the composite article is a multi-layered filament wound composite article produced by a filament winding process. The multi-layered filament wound composite article may be a utility pole.

The present invention pertains to a multi-layered filament wound composite article as just defined wherein the composite article is a composite module configured for use in a modular pole assembly, the composite module comprising a hollow tapered tubular pole section having an open base end and an opposed tip end, the diameter of the tip end being less than the diameter of the base end, such that the tip end of one module can fit into the base end of another module to a predetermined length to provide a modular pole assembly.

The present invention pertains to a composite module configured for use in a modular pole assembly, the composite module comprising:
an inner core comprising a first composite material; and
one or more than one outer layers comprising a second composite material overlaying the inner core, the second composite material comprising an aliphatic isocyanate polyurethane;
   wherein the concentration of aliphatic isocyanate in the second composite material is greater than the concentration of aliphatic isocyanate in the first composite material; and the composite module comprises a hollow tapered tubular pole section having an open base end and an opposed tip end, the diameter of the tip end being less than the diameter of the base end, such that the tip end of one module can fit into the base end of another module to a predetermined length to provide a modular pole assembly.

The present invention pertains to a composite article as just defined wherein the first composite material may comprise a resin with no aliphatic isocyanate therein. The first composite material may comprise from about 20 to about 85% by weight, or any amount therebetween, of a reinforcement and from about 15 to about 80% by weight, or any amount therebetween of a polyurethane resin. The polyurethane resin of the first composite material may comprise from about 20 to about 80% by weight, or any amount therebetween, of an aromatic polyisocyanate and from about 20 to about 80% by weight, or any amount therebetween, of a polyol. Other polyisocyanates may be present in the polyurethane resin of the first composite material, for example, the polyurethane resin may comprise from about 0% to about 40% by weight, or any amount therebetween, of an aliphatic polyisocyanate, provided that the amount of aliphatic isocyanate in the second composite material is greater than the amount of aliphatic isocyanate in the first composite material. The polyurethane resin of the first composite material may have a OH/NCO weight ratio from about 0.1:1 to about 5:1 (preferably from about 0.4:1 to about 1.5:1), or any amount therebetween. The second composite material may comprise from about 20 to about 85% by weight, or any amount therebetween, of a second reinforcement and from about 15 to about 80% by weight, or any amount therebetween of an aliphatic isocyanate polyurethane resin. The aliphatic isocyanate polyurethane resin of the second composite material may comprise from about 20 to about 80% by weight, or any amount therebetween, of an aliphatic polyisocyanate and from about 20 to about 80% by weight, or any amount therebetween, of a polyol. Other polyisocyanates may be present in the aliphatic isocyanate polyurethane resin of the second composite material, for example, the aliphatic isocyanate polyurethane resin may comprise from about 0% to about 40% by weight, or any amount therebetween, of an aromatic polyisocyanate, provided that the amount of aliphatic isocyanate in the aliphatic isocyanate polyurethane resin of the second composite material is greater than the amount of aliphatic isocyanate in the polyurethane resin of the first composite material. The aliphatic isocyanate polyurethane resin of the second composite material may have a OH/NCO weight ratio from about 0.1:1 to about 5:1 (preferably from about 0.4:1 to about 1.5:1), or any amount therebetween.

The present invention further pertains to a modular pole assembly comprising a plurality of composite modules of the present invention staked to form a vertical structure of selected height, wherein the base end of an overlying module is mated with the tip end of an underlying module.

The present invention further provides a method of manufacturing a composite article (Method A) comprising:
providing a core comprising a reinforcement impregnated with a first resin; mixing an aliphatic isocyanate component and a polyol component to produce a reaction mixture;
impregnating a second reinforcement with the reaction mixture to produce an impregnated reinforcement;
applying the impregnated reinforcement over an outside surface of the core; and
allowing the reaction mixture to set to produce a composite article with one or more than one outer layers of aliphatic isocyanate composite material;
   wherein the concentration of aliphatic isocyanate in the reaction mixture is greater than the concentration of aliphatic isocyanate in the first resin.

The present invention pertains to a method of manufacturing a composite article as just defined (Method A) wherein the first resin may contain no aliphatic isocyanate. The first resin may be a polyurethane resin and the core may comprise from about 20 to about 85% by weight, or any amount therebetween, of the reinforcement and from about 15 to about 80% by weight, or any amount therebetween of the polyurethane resin. The polyurethane resin of the core may comprise from about 20 to about 80% by weight, or any amount therebetween, of an aromatic polyisocyanate and from about 20 by weight, or any amount therebetween, of a polyol. Other polyisocyanates may be present in the polyurethane resin of the core, for example, the polyurethane resin may comprise from about 0% to about 40% by weight, or any amount therebetween, of an aliphatic polyisocyanate, provided that the concentration of aliphatic isocyanate in the reaction mixture is greater than the concentration of aliphatic isocyanate in the first resin. The polyurethane resin of the core may have a OH/NCO weight ratio from about 0.1:1 to about 5:1 (preferably from about 0.4:1 to about 1.5:1), or any amount therebetween. The one or more than one outer layers of aliphatic isocyanate composite material may comprise from about 20 to about 85% by weight, or any amount therebetween, of the second reinforcement and from about 15 to about 80% by weight, or any amount therebetween of the reaction mixture (aliphatic isocyanate polyurethane resin). The reaction mixture may comprise from about 20 to about 80% by weight, or any amount therebetween, of the aliphatic isocyanate component and from about 20 to about 80% by weight, or any amount therebetween, of the polyol component. The aliphatic isocyanate component of the reaction mixture may comprise at least 15 weight percent of an aliphatic polyisocyanate to give the required characteristics of UV stability and abrasion resistance. Other polyisocyanates may be present in the reaction mixture, for example, the reaction mixture may comprise from about 0% to about 40% by weight, or any amount therebetween, of an aromatic polyisocyanate, provided that the concentration of aliphatic isocyanate in the reaction mixture is greater than the concentration of aliphatic isocyanate in the first resin. The reaction mixture may have a OH/NCO weight ratio from about 0.1:1 to about 5:1 (preferably from about 0.4:1 to about 1.5:1), or any amount therebetween.

The present invention pertains to a method of manufacturing a composite article as just defined (Method A) wherein the aliphatic isocyanate component comprises hexamethylene diisocyanate (HDI), isophorone diisocyanate (IPDI) or a mixture thereof. Preferably the aliphatic isocyanate component comprises a mixture of aliphatic hexane 1,6-diisocyanato-homopolymer and hexamethylene diisocyanate (HDI).

The present invention pertains to a method of manufacturing a composite article as just defined (Method A) wherein the polyol component comprises from about 60 to about 100 weight percent polyether polyol and from about 0 to about 40 weight percent polyester polyol.

The present invention pertains to a method of manufacturing a composite article as just defined (Method A) wherein the polyether polyol has an equivalent weight in the range from about 70 to about 2500 and an hydroxyl functionality equal to or greater than about 2. Preferably the polyetherpolyol has an equivalent weight in the range from about 70 to about 400 and an hydroxyl functionality in the range from about 2 to about 6.

The present invention pertains to a method of manufacturing a composite article as just defined (Method A) wherein the polyester polyol has an equivalent weight in the range from about 70 to about 1000 and an hydroxyl functionality equal to or greater than about 2. Preferably the polyester polyol has an equivalent weight in the range from about 100 to about 300 and an hydroxyl functionality in the range from about 2 to about 6.

The present invention pertains to a method of manufacturing a composite article as just defined (Method A) wherein the reaction mixture further comprises a catalyst selected from the group consisting of tin, bismuth, zinc, titanium and mixtures thereof.

The present invention pertains to a method of manufacturing a composite article as just defined (Method A) wherein the composite article is produced using filament winding. The composite article may also be produced using pultrusion.

The present invention also pertains to a method of manufacturing a multi-layered filament wound composite article (Method B) comprising:
providing a core comprising reinforcement impregnated with a first resin; mixing an aliphatic isocyanate component and a polyol component to produce a reaction mixture;
impregnating a fibrous reinforcement with the reaction mixture to produce an impregnated fibrous reinforcement;
winding the impregnated fibrous reinforcement around an outside surface of the core to form a shaped article; and
allowing the reaction mixture to set to produce a multi-layered filament wound composite article with one or more than one outer layers of aliphatic isocyanate composite material;
   wherein the concentration of aliphatic isocyanate in the reaction mixture is greater than the concentration of aliphatic isocyanate in the first resin.

The present invention further pertains to a method of manufacturing a multi-layered filament wound composite article (Method C) comprising:
impregnating a fibrous reinforcement with a first resin to produce an impregnated fibrous reinforcement;
winding the impregnated fibrous reinforcement around an outside surface of a mandrel to form a shaped core;
mixing an aliphatic isocyanate component and a polyol component to produce a reaction mixture;
impregnating a second fibrous reinforcement with the reaction mixture to produce a second impregnated fibrous reinforcement;
winding the second impregnated fibrous reinforcement around an outside surface of the core to form a shaped article; and
allowing the reaction mixture to set to produce a multi-layered filament wound composite article with one or more outer layer of aliphatic isocyanate composite material;
   wherein the concentration of aliphatic isocyanate in the reaction mixture is greater than the concentration of aliphatic isocyanate in the first resin.

The present invention pertains to a method of manufacturing a multi-layered filament wound composite article as just defined (Method C) wherein the first resin contains no aliphatic isocyanate. The first resin may be a polyurethane resin and the core may comprise from about 20 to about 85% by weight, or any amount therebetween, of the fibrous reinforcement and from about 15 to about 80% by weight, or any amount therebetween of the polyurethane resin. The polyurethane resin of the core may comprise from about 20 to about 80% by weight, or any amount therebetween, of an aromatic polyisocyanate and from about 20 to about 80% by weight, or any amount therebetween, of a polyol. Other polyisocyanates may be present in the polyurethane resin of the core, for example, the polyurethane resin may comprise from about 0% to about 40% by weight, or any amount therebetween, of an aliphatic polyisocyanate, provided that the concentration of aliphatic isocyanate in the reaction mixture is greater than the concentration of aliphatic isocyanate in the first resin. The polyurethane resin of the core may have a OH/NCO weight ratio from about 0.1:1 to about 5:1 (preferably from about 0.4:1 to about 1.5:1), or any amount therebetween. The one or more than one outer layers of aliphatic isocyanate composite material may comprise from about 20 to about 85% by weight, or any amount therebetween, of the second reinforcement and from about 15 to about 80% by weight, or any amount therebetween of the reaction mixture (aliphatic isocyanate polyurethane resin). The reaction mixture may comprise from about 20 to about 80% by weight, or any amount therebetween, of the aliphatic isocyanate component and from about 20 to about 80% by weight, or any amount therebetween, of the polyol component. The aliphatic isocyanate component of the reaction mixture may comprise at least 15 weight percent of an aliphatic polyisocyanate to give the required characteristics of UV stability and abrasion resistance. Other polyisocyanates may be present in the reaction mixture, for example, the reaction mixture may comprise from about 0% to about 40% by weight, or any amount therebetween, of an aromatic polyisocyanate, provided that the concentration of aliphatic isocyanate in the reaction mixture is greater than the concentration of aliphatic isocyanate in the first resin. The reaction mixture may have a OH/NCO weight ratio from about 0.1:1 to about 5:1 (preferably from about 0.4:1 to about 1.5:1), or any amount therebetween.

The present invention pertains to a method of manufacturing a multi-layered filament wound composite article as just defined (Method C) wherein the aliphatic isocyanate component comprises hexamethylene diisocyanate (HDI), isophorone diisocyanate (IPDI) or a mixture thereof. Preferably the aliphatic isocyanate component comprises a mixture of aliphatic hexane 1,6-diisocyanato-homopolymer and hexamethylene diisocyanate (HDI).

The present invention pertains to a method of manufacturing a multi-layered filament wound composite article as just defined (Method C) wherein the polyol component comprises from about 60 to about 100 weight percent polyether polyol and from about 0 to about 40 weight percent polyester polyol.

The present invention pertains to method of manufacturing a multi-layered filament wound composite article as just defined (Method C) wherein the polyether polyol has an equivalent weight in the range from about 70 to about 2500 and an hydroxyl functionality equal to or greater than about 2. Preferably the polyether polyol has an equivalent weight in the range from about 70 to about 400 and an hydroxyl functionality in the range from about 2 to about 6.

The present invention pertains to a method of manufacturing a multi-layered filament wound composite article as just defined (Method C) wherein the polyester polyol has an equivalent weight in the range from about 70 to about 1000 and an hydroxyl functionality equal to or greater than about 2. Preferably the polyester polyol has an equivalent weight in the range from about 100 to about 300 and an hydroxyl functionality in the range from about 2 to about 6.

The present invention pertains to a method of manufacturing a multi-layered to filament wound composite article as just defined (Method C) wherein the reaction mixture further comprises a catalyst selected from the group consisting of tin, bismuth, zinc, titanium and mixtures thereof.

The present invention pertains to a method of manufacturing a multi-layered filament wound composite article as just defined (Method C) wherein the composite article is an utility pole.

The present invention pertains to a method of manufacturing a multi-layered filament wound composite article as just defied (Method C) wherein the composite article is a composite module configured for use in a modular pole assembly.

By manufacturing a composite article with an outer layer that comprises reinforcement embedded in a thermosetting polyurethane resin, the polyurethane resin characterized as having a concentration of an aliphatic isocyanate from about 20 to about 80% by weight, or any amount therebetween, and from about 20 to about 80% by weight, or any amount therebetween, of a polyol, the composite article is well suited for uses that involve UV exposure. Furthermore, by manufacturing the composite article with an inner core comprising reinforcement embedded in an aromatic isocyanate polyurethane, or other resin, for example, but not limited to, polyester, epoxy, or vinylester resin or mixtures thereof, with little or no aliphatic isocyanate polyurethane, the composite article maintains the strength and durability associated with composite articles, yet the cost of the composite article is significantly less than that of a composite article manufactured with a homogenous distribution of aliphatic isocyanate polyurethane throughout the article. Polyurethane resins have the additional advantage of typically being VOC free.

This summary of the invention does not necessarily describe all features of the invention.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 shows a schematic side elevation view of an example of an embodiment of the composite module pole assembly of the present invention, where a series of composite modules are used to construct a range of 30 ft poles of varying strength and stiffness.

FIG. 2 shows a schematic side elevation view of an example of an embodiment of the composite module pole assembly of the present invention, where a series of composite modules are used to construct a range of 45 ft poles of varying strength and stiffness.

FIG. 3 shows a schematic side elevation view of an example of an embodiment of the composite module pole assembly of the present invention, where a series of composite modules are used to construct a range of 60 ft poles of varying strength and stiffness.

FIG. 4 shows a schematic side elevation view of an example of an embodiment of the composite module pole assembly of the present invention, where a series of composite modules are used to construct a range of 75 ft poles of varying strength and stiffness.

FIG. 5 shows a schematic side elevation view of an example of an embodiment of the composite module pole assembly of the present invention, where a series of composite modules are used to construct a range of 90 ft poles of varying strength and stiffness.

FIG. 6 shows a schematic view of an example of an embodiment of the composite module of the present invention, showing seven differing sizes of modules.

FIG. 7 shows a schematic view of an example of an embodiment of the composite module of the present invention, with modules being nested together in preparation for transport.

FIG. 8 shows an exploded perspective view, in section, of an example of an embodiment of the composite module pole assembly of the present invention, where several composite modules are stacked one on top of the other, together with mating top cap and mating bottom plug.

### DETAILED DESCRIPTION

The present invention relates to a composite article and a method of manufacturing such a composite article.

The following description is of a preferred embodiment.

The present invention provides a multi-layered composite article that has an inner core comprising a first composite material with one or more than one outer layers of a second composite material, the second composite material comprising an aliphatic isocyanate polyurethane overlaying the inner core. The concentration of aliphatic isocyanate in the aliphatic isocyanate polyurethane composite material (the second composite material) is higher than the concentration of aliphatic isocyanate in the first composite material.

Preferably, the one or more than one outer layers of aliphatic isocyanate composite material bind to the inner core to provide an integral composite article.

Aliphatic isocyanate polyurethane resin has superior resistance to weathering and UV rays, however aliphatic polyisocyanate polyurethane resin is generally much more expensive than other resins, such as, but not limited to, aromatic polyisocyanate polyurethane resin, polyester, epoxy, or vinylester resin or mixtures thereof. A composite article having one or more outer layers of an aliphatic isocyanate polyurethane composite material and an inner core made from a different composite material with a lower concentration of aliphatic isocyanate therein (and preferably no aliphatic isocyanate therein) advantageously possesses UV stability and superior abrasion resistance, while being less expensive to produce than a composite article manufactured with a homogenous distribution of aliphatic isocyanate polyurethane throughout the article. This is particularly beneficial for large composite articles that are to be utilized outside for long periods of time, such as, but not limited to, utility poles, pipes, posts, fencing materials, guard rails, scaffolding, building materials, and other materials that may be used outdoors.

The first composite material preferably comprises an aromatic isocyanate polyurethane composite material. Aromatic polyisocyanates are typically less expensive than aliphatic polyisocyanates and produce polyurethane composite material with good strength characteristics. A composite article with an aromatic isocyanate polyurethane composite core and an outer layer(s) of aliphatic isocyanate polyurethane composite material has the combined advantages of strength, UV stability and abrasion resistance, while being economic to produce even when large composite articles are required, such as, but not limited to, utility poles or posts, building, and other structural materials.

In an embodiment of the present invention, there is provided a method of manufacturing a composite article comprising:
providing a core comprising reinforcement impregnated with a first resin;
mixing an aliphatic isocyanate component and a polyol component to produce a reaction mixture;
impregnating a second reinforcement with the reaction mixture to produce an impregnated reinforcement;
applying the impregnated reinforcement over an outside surface of the core; and
allowing the reaction mixture to set to produce a composite article with one or more than one outer layer of aliphatic isocyanate composite material;
   wherein the concentration of aliphatic isocyanate in the reaction mixture is higher than the concentration of aliphatic isocyanate in the first resin.

The first resin may be a polyurethane resin and the core may comprise from about 20 to about 85% by weight, or any amount therebetween, of the reinforcement, for example 22, 24, 26, 28, 30, 32, 34, 36, 38, 40, 42, 44, 46, 48, 50, 52, 54, 56, 58, 60, 62, 64, 66, 68, 70, 72, 74, 76, 78, 80 and 82 weight percent, or any amount therebetween, and from about 15 to about 80% by weight, or any amount therebetween of the polyurethane resin, for example 18, 20, 22, 24, 26 28, 30, 32, 34, 36, 38, 40, 42, 44, 46, 48, 50, 52, 54, 56, 58, 60, 62, 64, 66, 68, 70, 72, 74, 76 and 78 weight percent, or any amount therebetween.

The first resin may comprise predominantly an aromatic isocyanate polyurethane resin, from about 20 to about 80% by weight, or any amount therebetween, of an aromatic polyisocyanate, for example 22, 24, 26 28, 30, 32, 34, 36, 38, 40, 42, 44, 46, 48, 50, 52, 54, 56, 58, 60, 62, 64, 66, 68, 70, 72, 74, 76, and 78 weight percent, or any amount therebetween, and from about 20 to about 80% by weight, or any amount therebetween, of a polyol, for example 22, 24, 26 28, 30, 32, 34, 36, 38, 40, 42, 44, 46, 48, 50, 52, 54, 56, 58, 60, 62, 64, 66, 68, 70, 72, 74, 76, and 78 weight percent, or any amount therebetween. Other polyisocyanates may be present in the polyurethane resin, for example, the polyurethane resin may comprise from about 0% to about 40% by weight, or any amount therebetween, of an aliphatic polyisocyanate, for example 2, 4, 6, 8, 10, 12, 14, 16, 18, 20, 22, 24, 26 28, 30, 32, 34, 36 and 38 weight percent, or any amount therebetween, provided that the concentration of aliphatic isocyanate in the reaction mixture is greater than the concentration of aliphatic isocyanate the first resin.

The polyurethane resin of the core may have a OH/NCO weight ratio from about 0.1:1 to about 5:1, or any amount therebetween, for example a ratio of 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2.0:1, 2.2:1, 2.4:1, 2.6:1, 2.8:1, 3.0:1, 3.2:1, 3.4:1, 3.6:1, 3.8:1, 4.0:1, 4.2:1, 4.4:1, 4.6:1, and 4.8:1, or any amount therebetween and preferably has a ratio from about 0.4:1 to about 1.5:1, or any amount therebetween, for example a ratio of 0.5:1, 0.6:1, 0.7:1, 0.8:1, 0.9:1, 1:1, 1.1:1, 1.2:1, 1.3:1 and 1.4:1, or any amount therebetween.

The first resin of the core may be allowed to set before or after the reaction mixture impregnated reinforcement is applied to an outside surface of the core, or it may be used after a predetermined amount of set time. The core may be pre-manufactured at a different time, location, or both. The first resin may contain no aliphatic isocyanate and may comprise an aromatic isocyanate polyurethane resin.

The one or more than one outer layers of aliphatic isocyanate composite material may comprise from about 20 to about 85% by weight, or any amount therebetween, of the second reinforcement, for example 22, 24, 26, 28, 30, 32, 34, 36, 38, 40, 42, 44, 46, 48, 50, 52, 54, 56, 58, 60, 62, 64, 66, 68, 70, 72, 74, 76, 78, 80 and 82 weight percent, or any amount therebetween, and from about 15 to about 80% by weight, or any amount therebetween of the reaction mixture (aliphatic isocyanate polyurethane resin), for example 18, 20, 22, 24, 26 28, 30, 32, 34, 36, 38, 40, 42, 44, 46, 48, 50, 52, 54, 56, 58, 60, 62, 64, 66, 68, 70, 72, 74, 76 and 78 weight percent, or any amount therebetween.

The reaction mixture may comprise from about 20 to about 80% by weight, or any amount therebetween, of the aliphatic isocyanate component, for example 22, 24, 26 28, 30, 32, 34, 36, 38, 40, 42, 44, 46, 48, 50, 52, 54, 56, 58, 60, 62, 64, 66, 68, 70, 72, 74, 76, and 78 weight percent, or any amount therebetween, and from about 20 to about 80% by weight, or any amount therebetween, of the polyol component, for example 22, 24, 26 28, 30, 32, 34, 36, 38, 40, 42, 44, 46, 48, 50, 52, 54, 56, 58, 60, 62, 64, 66, 68, 70, 72, 74, 76, and 78 weight percent, or any amount therebetween.

The aliphatic isocyanate component of the reaction mixture may comprise at least 15 weight percent of an aliphatic polyisocyanate to give the required characteristics of UV stability and abrasion resistance. The amount of aliphatic isocyanate in the aliphatic polyisocyanate component may be from about 15 to about 100 weight percent or any amount therebetween, for example 18, 20, 22, 24, 26 28, 30, 32, 34, 36, 38, 40, 42, 44, 46, 48, 50, 52, 54, 56, 58, 60, 62, 64, 66, 68, 70, 72, 74, 76, 78 80, 82, 84, 86, 88, 90, 92, 94, 96, 98 and 100 weight percent, or any amount therebetween. Preferably the aliphatic isocyanate content of the aliphatic polyisocyanate component is from about 30 to about 100 weight percent, or any amount therebetween, or from about 50 to about 100 weight percent or any amount therebetween. The present invention also contemplates that the only isocyanates present in the aliphatic polyisocyanate component may be aliphatic isocyanates.

Other polyisocyanates may be present in the reaction mixture, for example, the reaction mixture may comprise from about 0% to about 40% by weight, or any amount therebetween, of an aromatic polyisocyanate, for example 2, 4, 6, 8, 10, 12, 14, 16, 18, 20, 22, 24, 26 28, 30, 32, 34, 36 and 38 weight percent, or any amount therebetween, provided that the concentration of aliphatic isocyanate in the reaction mixture is greater than the concentration of aliphatic isocyanate in the first resin. The reaction mixture may have a OH/NCO weight ratio from about 0.1:1 to about 5:1, or any amount therebetween, for example a ratio of 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2.0:1, 2.2:1, 2.4:1, 2.6:1, 2.8:1, 3.0:1, 3.2:1, 3.4:1, 3.6:1, 3.8:1, 4.0:1, 4.2:1, 4.4:1, 4.6:1, and 4.8:1, or any amount therebetween and preferably has a ratio from about 0.4:1 to about 1.5:1, or any amount therebetween, for example a ratio of 0.5:1, 0.6:1, 0.7:1, 0.8:1, 0.9:1, 1:1, 1.1:1, 1.2:1, 1.3:1 and 1.4:1, or any amount therebetween.

A polyurethane resin or reaction mixture is made by mixing a polyol component and a polyisocyanate component. Other additives may also be included, such as fillers, pigments, plasticizers, curing catalysts, UV stabilizers, antioxidants, microbiocides, algicides, dehydrators, thixotropic agents, wetting agents, flow modifiers, matting agents, deaerators, extenders, molecular sieves for moisture control and desired colour, UV absorber, light stabilizer and fire retardants.

By the term “aliphatic isocyanate” it is meant an isocyanate in which NCO groups are either attached to an aliphatic center or not attached directly to an aromatic ring. It is also within the scope of the present invention that the term “aliphatic isocyanate” means an isocyanate in which the NCO groups are attached to an aliphatic center. Aliphatic isocyanates described in U.S. Pat. No. 6,420,493 (which is incorporated herein by reference) may be used in the resin compositions described herein. Aliphatic isocyanates may include, but are not limited to, hexamethylene diisocyanate (HDI), isophorone diisocyanate (IPDI), dicyclohexane-4,4′ diisocyanate (Desmodur W), hexamethylene diisocyanate trimer (HDI Trimer), isophorone diisocyanate trimer (IPDI Trimer), hexamethylene diisocyanate biuret (HDI Biuret), cyclohexane diisocyanate, meta-tetramethylxylene diisocyanate (TMXDI), and mixtures thereof. The aliphatic isocyanate may include a polymeric aliphatic diisocyanate, for example, but not limited to a uretidione, biuret, or allophanate polymeric aliphatic diisocyanate, or a polymeric aliphatic diisocyanate in the symmetrical or asymmetrical trimer form, or a mixture thereof, which typically does not present a toxic hazard on account of extremely low volatility due to very low monomer content. The aliphatic isocyanates, employed to produce the composite article of the present invention or that are used in the method of the present invention may be hexamethylene diisocyanate (HDI), isophorone diisocyanate (IPDI) or a mixture thereof, and is preferably a mixture of aliphatic hexane 1,6-diisocyanato-homopolymer and hexamethylene diisocyanate (HDI). Hexamethylene diisocyanate polyisocyanates described in EP-A 668 330 to Bayer AG; EP-A 1 002 818 to Bayer AG; and WO 98/48947 to Valspar Corp (which are incorporated herein by reference) may be used in the aliphatic isocyanate resin composition described herein.

By the term “polyol” it is meant a composition that contains a plurality of active hydrogen groups that are reactive towards the polyisocyanate component under the conditions of processing. Polyols described in U.S. Pat. No. 6,420,493 may be used in the resin compositions described herein. The polyol component may include, but is not limited to, a polyether polyol, a polyester polyol, or a mixture thereof. The polyester polyol may be, but is not limited to a diethylene glycol-phthalic anhydride based polyester polyol. The polyether polyols may be, but is not limited to, polyoxyalkylene polyol, propoxylated glycerol, branched polyol with ester and ether groups, amine initiated-hydroxyl terminated polyoxyalkylene polyol and mixtures thereof.

By the term “aromatic isocyanate” it is meant an isocyanate in which NCO groups are attached to an aromatic ring. Aromatic isocyanates described in U.S. Pat. No. 6,420,493 may be used in the resin composition described herein. Aromatic isocyanates may include, but are not limited to, methylene di-p-phenylene isocyanate, polymethylene polyphenyl isocyanate, methylene isocyanatobenzene or a mixture thereof. The aromatic polyisocyanate may include from about 30% to about 60% by weight, or any amount therebetween, of methylene di-p-phenylene isocyanate, from about 30% to about 50% by weight, or any amount therebetween of polymethylene polyphenyl isocyanate, with a balance of methylene isocyanatobenzene.

By the term “composite material” it is meant a material composed of reinforcement embedded in a polymer matrix or resin, for example, but not limited to, polyester, epoxy, polyurethane, or vinylester resin or mixtures thereof. The matrix or resin holds the reinforcement to form the desired shape while the reinforcement generally improves the overall mechanical properties of the matrix.

By the term “reinforcement” it is meant a material that acts to further strengthen a polymer matrix of a composite material for example, but not limited to, fibers, particles, flakes, fillers, or mixtures thereof. Reinforcement typically comprises glass, carbon, or aramid, however there are a variety of other reinforcement materials, which can be used as would be known to one of skill in the art. These include, but are not limited to, synthetic and natural fibers or fibrous materials, for example, but not limited to polyester, polyethylene, quartz, boron, basalt, ceramics and natural reinforcement such as fibrous plant materials, for example, jute and sisal.

By the term “aliphatic isocyanate composite material” it is meant a composite material comprising reinforcement embedded in an aliphatic isocyanate thermosetting polyurethane resin predominantly comprising an aliphatic polyisocyanate component and a polyol component. The thermosetting resin is set or cured to provide a substantially solid matrix for the reinforcement. Other components may also be present in the aliphatic isocyanate thermosetting polyurethane resin, for example, but not limited to aromatic polyisocyanate provided that the concentration of aliphatic isocyanate in the reaction mixture is greater than the concentration of aliphatic isocyanate in the first resin. The “second composite material” may be comprised predominantly of reinforcement and an aliphatic isocyanate thermosetting polyurethane resin, and may be referred to as an aliphatic isocyanate composite material.

By the term “aromatic isocyanate composite material” it is meant a composite material comprising reinforcement embedded in a aromatic isocyanate thermosetting polyurethane resin comprising predominantly an aromatic polyisocyanate component and a polyol component. The thermosetting resin is set or cured to provide a substantially solid matrix for the reinforcement. Other components may also be present in the aromatic isocyanate thermosetting polyurethane resin, for example, but not limited to an aliphatic isocyanate, provided that the concentration of aliphatic isocyanate in the reaction mixture is greater than the concentration of aliphatic isocyanate in the first resin. The “first composite material” may be comprised predominantly of reinforcement and an aromatic isocyanate thermosetting polyurethane resin, and may be referred to as an aromatic isocyanate composite material.

The aliphatic polyisocyanate component of the aliphatic isocyanate thermosetting polyurethane resin may comprise at least 15 weight percent of an aliphatic isocyanate to give the required characteristics of UV stability and abrasion resistance. The amount of aliphatic isocyanate in the aliphatic polyisocyanate component may be from about 15 to about 100 weight percent or any amount therebetween, for example 18, 20, 22, 24, 26 28, 30, 32, 34, 36, 38, 40, 42, 44, 46, 48, 50, 52, 54, 56, 58, 60, 62, 64, 66, 68, 70, 72, 74, 76, 78 80, 82, 84, 86, 88, 90, 92, 94, 96, 98 and 100 weight percent, or any amount therebetween. Preferably the aliphatic isocyanate content of the aliphatic polyisocyanate component is from about 30 to about 100 weight percent, or any amount therebetween, or from about 50 to about 100 weight percent or any amount therebetween. The present invention also contemplates that the only isocyanates present in the aliphatic polyisocyanate component may be aliphatic isocyanates.

The aromatic polyisocyanate component of the aromatic isocyanate thermosetting polyurethane resin may comprises at least 20 weight percent of an aromatic isocyanate to give the desired strength characteristics. The amount of aromatic isocyanate in the aromatic polyisocyanate component may be from about 20 to about 100 weight percent or any amount therebetween for example 20, 22, 24, 26 28, 30, 32, 34, 36, 38, 40, 42, 44, 46, 48, 50, 52, 54, 56, 58, 60, 62, 64, 66, 68, 70, 72, 74, 76, 78 80, 82, 84, 86, 88, 90, 92, 94, 96, 98 and 100 weight percent, or any amount therebetween. Preferably the aromatic-isocyanate content of the aromatic polyisocyanate component is from about 30-100 weight percent or any amount therebetween, or from about 40 to about 100 weight percent, or any amount therebetween. It is also contemplated that only isocyanates present in the aromatic polyisocyanate component may be aromatic isocyanates.

The polyol component may comprise from about 60 to about 100 weight percent polyetherpolyol, or any amount therebetween, for example 62, 64, 66, 68, 70, 72, 74, 76, 78, 80, 82, 84, 86, 88, 90, 92, 94, 96 and 98 weight percent, or any amount therebetween. The polyether polyol may have an equivalent weight between about 70 and about 2500, or any amount therebetween, for example, 100, 130, 160, 190, 220, 250, 280, 310, 340, 370, 400, 430, 460, 490, 520, 550, 580, 610, 640, 670, 700, 730, 760, 790, 820, 850, 880, 910, 940, 970, 1000, 1100, 1200, 1300, 1400, 1500, 1600, 1700, 1800, 1900, 2000, 2100, 2200, 2300, and 2400 or any amount therebetween, and preferably has an equivalent weight between about 70 and about 400, or any amount therebetween, and an hydroxyl functionality of between about 2 and about 6 or any amount therebetween, for example, 2.2, 2.4, 2.6, 2.8, 3.0.3.2, 3.4, 3.6, 3.8, 4.0, 4.2, 4.4, 4.6, 4.8, 5.0, 5.2, 5.4, 5.6, and 5.8 or any amount therebetween.

The polyol component may comprise from about 0 to about 40 weight percent polyester polyol or any amount therebetween, for example 2, 4, 6, 8, 10, 12, 14, 16, 18, 20, 22, 24, 26, 28, 30, 32, 34, 36 and 38 weight percent, or any amount therebetween. The polyester polyol may have an equivalent weight between about 70 and about 1000, or any amount therebetween, for example, 100, 130, 160, 190, 220, 250, 280, 310, 340, 370, 400, 430, 460, 490, 520, 550, 580, 610, 640, 670, 700, 730, 760, 790, 820, 850, 880, 910, 940, 970, and 1000 or any amount therebetween, preferably has an equivalent weight between about 100 and about 300, or any amount therebetween, and an hydroxyl functionality of between about 2 and about 6 or any amount therebetween, for example, 2.2, 2.4, 2.6, 2.8, 3.0.3.2, 3.4, 3.6, 3.8, 4.0, 4.2, 4.4, 4.6, 4.8, 5.0, 5.2, 5.4, 5.6, and 5.8 or any amount therebetween.

The aromatic or aliphatic thermosetting polyurethane resin utilized by the present invention may further comprise from about 2 to about 20 weight percent of a suitable chain extender, or any amount therebetween, for example 5, 7, 9, 11, 13, 15, 17, and 19 weight percent, or any amount therebetween. By the term “chain extender” it is meant a difunctional, low-molecular, multi-functional compound, which is reactive towards isocyanates. A suitable chain extender may have an equivalent weight between about 45 and about 400, or any amount therebetween, for example 70, 100, 130, 160, 190, 220, 250, 280, 310, 340, and 370 or any amount therebetween, and an hydroxyl functionality of at least 2. Preferably the chain extender employed in the resin comprises 1,4-butanediol.

The aromatic or aliphatic thermosetting polyurethane resin utilized by the present invention may also include known additives used in polyurethane technology, for example, but not limited to, fillers, pigments, plasticizers, curing catalysts, UV stabilizers, antioxidants, microbiocides, algicides, dehydrators, thixotropic agents, wetting agents, flow modifiers, matting agents, deaerators, extenders, molecular sieves for moisture control and desired colour, UV absorber, light stabilizer, fire retardants or mixtures thereof. As hereinbefore describe in more detail, an aliphatic isocyanate polyurethane resin has superior resistance to UV rays. The UV stability can be further enhanced by addition of a UV stabilizer, a UV absorber, an antioxidant or a mixture thereof. Pot life of the resin can be adjusted by inclusion of a suitable catalyst, for example, but not limited to, a tin catalyst, bismuth catalyst, zinc catalyst, titanium catalyst or a mixture thereof.

One method of manufacture of the composite article of the present invention utilizes filament winding. However, other methods may be used to produce the composite article of the present invention, for example pultrusion.

A typical filament winding set-up is described in CA 2,444,324 and CA is 2,274,328 (which is incorporated herein by reference). In the method of filament winding, fibrous reinforcement, for example, but not limited to glass, carbon, or aramid, is impregnated with resin, and wound onto an elongated mandrel of predetermined shape. The winding process can be done directly on a substrate that can act as a mandrel, or it can be done using a mandrel that is removable or dissolvable after the part is cured. The later type of mandrels may be used to produce large structures, for example, utility poles.

The resin impregnated fibrous material is typically wound onto the mandrel in a predetermined sequence. This sequence may involve winding layers of fibres at a series of angles ranging between 0° and 87° relative to the mandrel axis. The direction that the fibrous reinforcement is laid onto the mandrel may effect the eventual strength and stiffness of the finished composite article. Other factors that may effect the structural properties of the manufactured composite article include the fibrous reinforcement to resin ratio, the wrapping sequence, the wall thickness, the type of fibrous reinforcement (such as glass, carbon, aramid and the like) and the type of resin used.

In accordance with one embodiment of the present invention, filament winding is used to produce the composite article of the present invention using at least two different resins compositions in the filament winding process. In this embodiment a first resin, for example, but not limited to, a polyester, an epoxy, a vinylester, a polyurethane, or mixtures thereof, is used to impregnate fibrous reinforcement which is then wound around the length of the mandrel for one or more than one full pass to obtain a thickness of from about 50% to about 98%, or any amount therebetween, of the final thickness of the finished composite material. The resin bath or other impregnation structure is then charged with an aliphatic isocyanate polyurethane resin composition comprising an aliphatic isocyanate component and a polyol component. Fibrous reinforcement is impregnated with the aliphatic isocyanate resin composition and wound on top of the first resin impregnated fibers for one or more than one full pass to obtain a thickness of from about 2% to about 50%, or any amount therebetween, of the final thickness of the finished composite material. Multiple layers of aliphatic isocyanate resin impregnated fibers may be wound onto the mandrel. The resin is allowed to cure and the mandrel may be removed or dissolved as would be apparent to one of skill in the art.

The finished composite article may comprise between about 5 and about 30 layers (preferably between about 10 and about 15 layers) of resin impregnated fibrous reinforcement, or any amount therebetween. The inner core comprising fibrous reinforcement impregnated with the first resin may comprises between about 4 and about 28 layers (preferably between about 9 and about 14 layers) of the composite article, or any amount therebetween, and the outer aliphatic isocyanate resin impregnated fibers may comprises between about 1 and about 10 layers (preferably between about 1 and about 5 layers), or any amount therebetween of the composite article.

The may be a delay between winding of the first resin impregnated fibers onto the mandrel and winding of the aliphatic isocyanate resin impregnated fibers, to allow the first resin to cure or set to produce a pre-formed composite material core (first composite material). This can be done by placing the mandrel in an oven. Alternatively, the winding of the aliphatic isocyanate resin impregnated fibers may be carried out substantially consecutively with winding of the first resin impregnated fibers onto the mandrel, and the aliphatic isocyanate resin impregnated reinforcement wound immediately, or after a partial curing of the first composite material, for example after reaching from about 30 to about 90%, or any amount therebetween of its final hardness.

The first resin may comprise a non-aliphatic polyurethane resin and preferably comprises an aromatic isocyanate polyurethane resin comprising an aromatic isocyanate and a polyol. A plurality of different resin compositions may be used in the filament winding process to produce a composite article having layers of different composite material, provided the outside layer or layers comprises an aliphatic isocyanate polyurethane composite material comprising from about 20 to about 100 weight percent, or any amount therebetween, aliphatic isocyanate polyurethane resin.

The composite article of the present invention may be a utility pole, however, the composite article is not limited to a utility pole and may include other structural articles, for example, posts, scaffolding, fencing materials, building materials and the like. In the case of a utility pole, it is preferred that the pole be made by filament winding substantially as described herein.

As disclosed in the examples, a utility pole comprising an aliphatic isocyanate composite outer layer may be subjected to prolonged sand blasting and UV exposure without showing any significant degradation of physical and mechanical properties indicating U stability and abrasion resistance. Furthermore, the Interlaminar Shear Strength results indicate that the top or outer layer of aliphatic composite material remains fully bound and integral with the inner core layers of the pole following prolonged sand blasting and UV exposure.

According to an alternative embodiment of the present invention, there is provided a composite module configured for use in a modular pole assembly, the composite module comprising one or more than one inner layers of a first resin composite material (preferably an aromatic isocyanate polyurethane composite material) and one or more than one outer layers of a second composite material (an aliphatic isocyanate polyurethane composite material). The composite module of the present invention may further include one or more than one intermediate layers of at least one further resin composite material different from the first resin composite material. The composite module of the present invention is preferably made using filament winding.

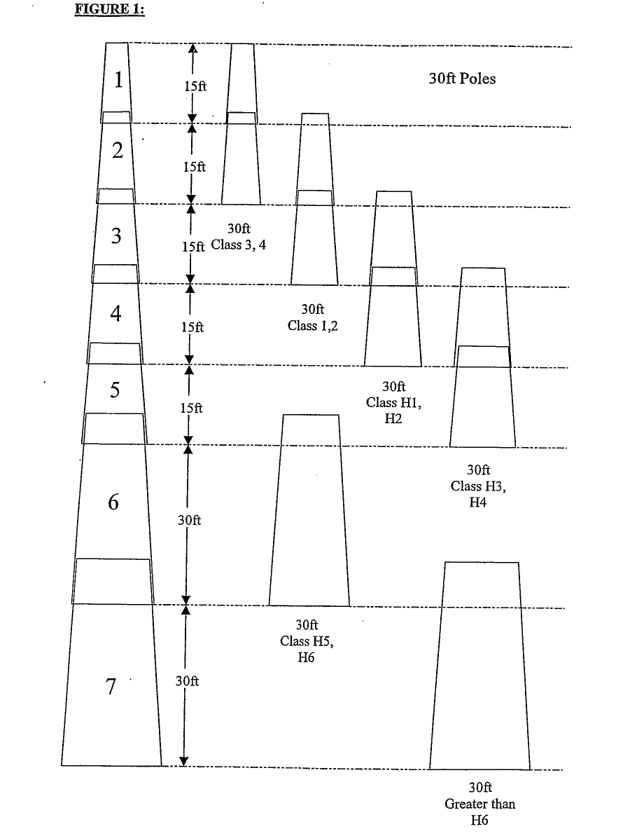

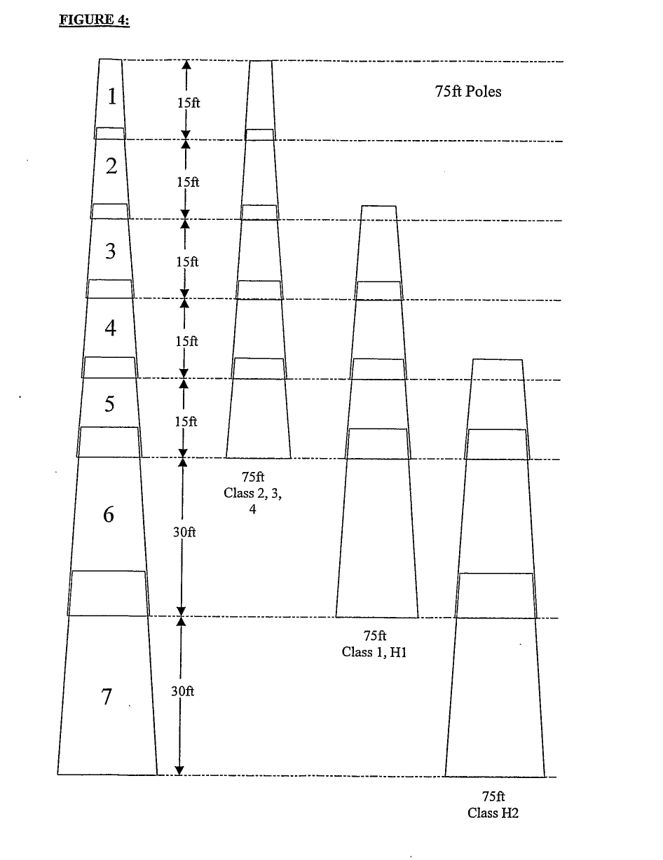

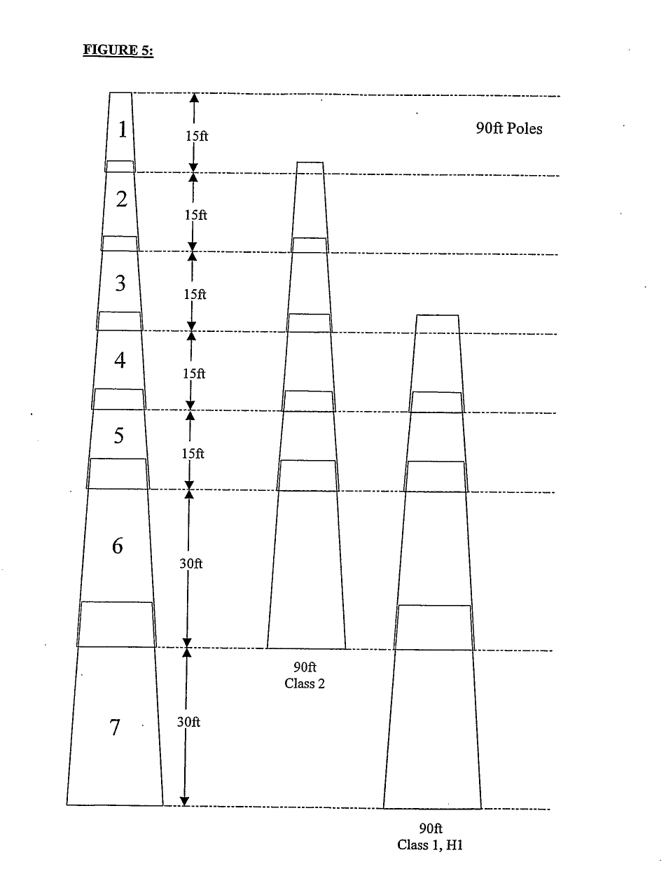

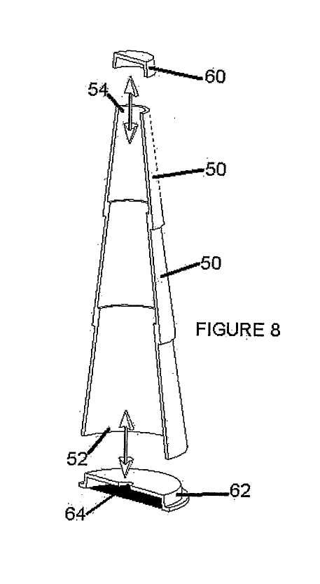

The composite module of the present invention may be a hollow tapered tubular pole section (e.g. 50, FIG. 8) having an open base (or first) end (e.g. 52, FIG. 8) and an opposed tip (or second) end (e.g. 54, FIG. 8), the diameter of the tip end being less than the diameter of the base end. Two or more composite modules of the present invention may be stacked one on top of the other such that the top end of one slips into, or matingly engages with, the base of another to a predetermined length to provide a modular pole assembly (e.g. see FIGS. 1-5 and 8). When the modules are stacked together they behave as a single structure able to resist forces, for example but not limited to lateral and compression forces, to a predetermined level. The height of the structure can be varied simply by adding or removing modules from the stack. The overall strength of the structure can be altered for the same height condition simply by removing a higher module from the top of the stack and replacing the length by adding a larger, stronger module at the base of the stack. In this way the structure can be engineered to vary not only strength but also stiffness characteristics for any desired height.

Accordingly there is further provided by the present invention, a modular pole assembly comprising a plurality of composite modules matingly engaged to form a vertical structure of selected height, wherein the base end of an overlying module is mated with the tip end of an underlying module.

The module pole assembly of the present invention comprising a plurality of staked composite modules having an outer layer of predominantly an aliphatic isocyanate polyurethane composite material advantageously has UV stability and superior abrasion resistance than a pole comprised of an aromatic isocyanate composite material, while being less expensive to produce than a module pole assembly having modules made purely from aliphatic isocyanate polyurethane composite material throughout. This is particularly advantageous for module pole assemblies at are to be utilized outside for long periods of time, such as, but not limited to, utility poles.

The modular pole assembly provides a solution for use in the electrical utility industry which has traditionally used steel and wood as distribution and transmission poles. For this application, a pole has to be of a defined height and have a specified minimum breaking strength and usually a defined deflection under a specified load condition. Poles can be specified to carry power lines across a terrain and accommodate any topography and structural forces resulting from effects such as wind and ice loading.

The electrical utility industry typically uses poles in lengths of 25 ft to 150 ft. These poles vary in length and in their strength requirements. As range of pole sizes and pole classes are required to meet these needs, the amount of inventory required is a multiple of these two parameters. In situations where flexibility to meet a desired need is warranted, large stocks of poles are required. The composite module of the present invention is configured for staking in a modular pole assembly and advantageously provides a lightweight structure that displays superior strength and durability when compared to the strength and durability associated with wood or steel poles. The composite modules of the present invention do not rust like steel and they do not rot or suffer microbiological or insect attack as is common in wood structures. Furthermore, fibre reinforced composite structures, in contrast to natural products (such as wood), are designed so the consistency and service life can be closely determined and predicted.

The composite module of the present invention may be constructed so that the dimensions allow the tip of the tapered section to fit inside the base of the ascending module. In the same way the base of the module may be constructed so it will fit onto the tip of the descending module. The overlaps of these joint areas may be predetermined so that adequate load transfer can take place from one module and the next. This overlap may vary throughout the structure generally getting longer as the modules descend in order to maintain sufficient load transfer when reacting against increasing levels of bending moment.

The joints are designed so they will affect sufficient load transfer without the use of additional fasteners, for example press fit connections, bolts, metal banding and the like. However, a fastener may be used sometimes in situations where the stack of modules is subjected to a tensile (upward force) rather than the more usual compressive (downwards force) or flexural loading.

FIG. 1 shows a series of composite modules stacked together to form a pole. Modules 1 to 5 are 15 ft long plus an allowance for the overlap length. Therefore, joining modules 1 and 2 results in a 30 ft pole. Joining modules 1, 2 and 3 results in a 45 ft pole. As each successive module is added the pole can increase in height at 15 ft intervals.

In cases where the stack does not begin with module 1, the resultant length includes the additional length of the overlap. For example. Modules 2, 3 and 4 would result in a pole like structure that would measure 45 ft plus the additional overlap length at the tip of module 2. If desired, the additional length can be simply cut off so the pole meets with height requirements.

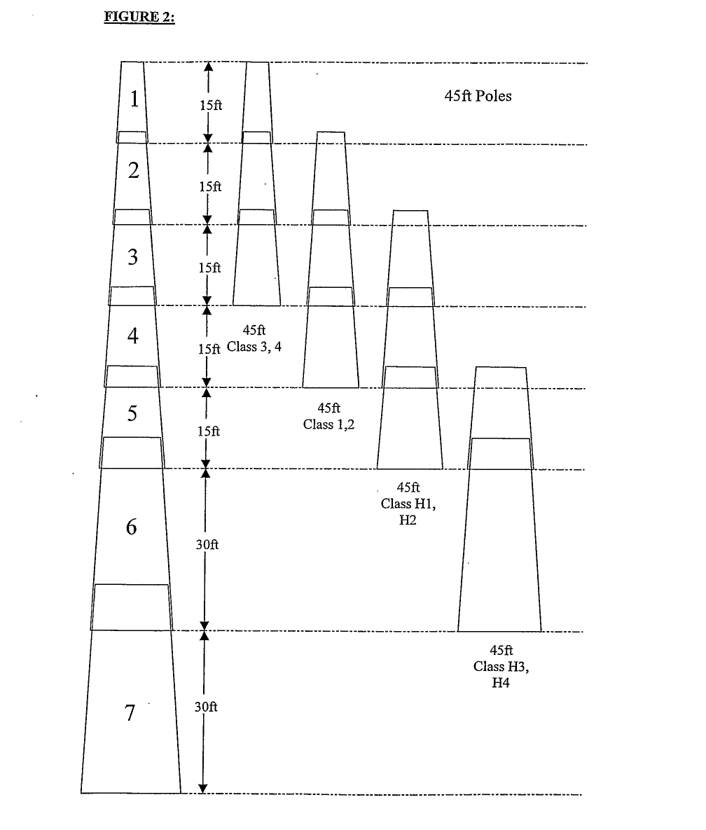

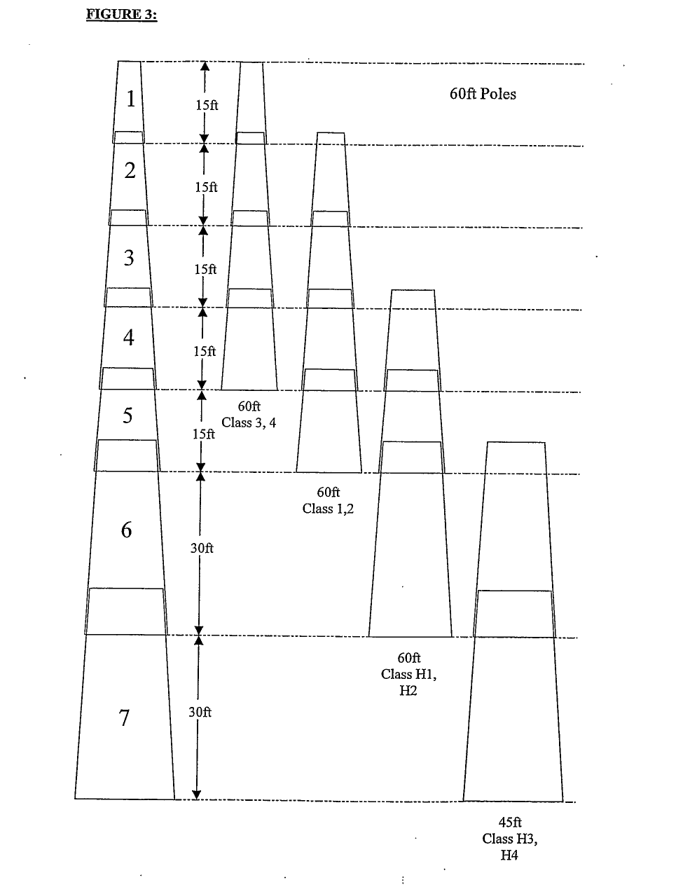

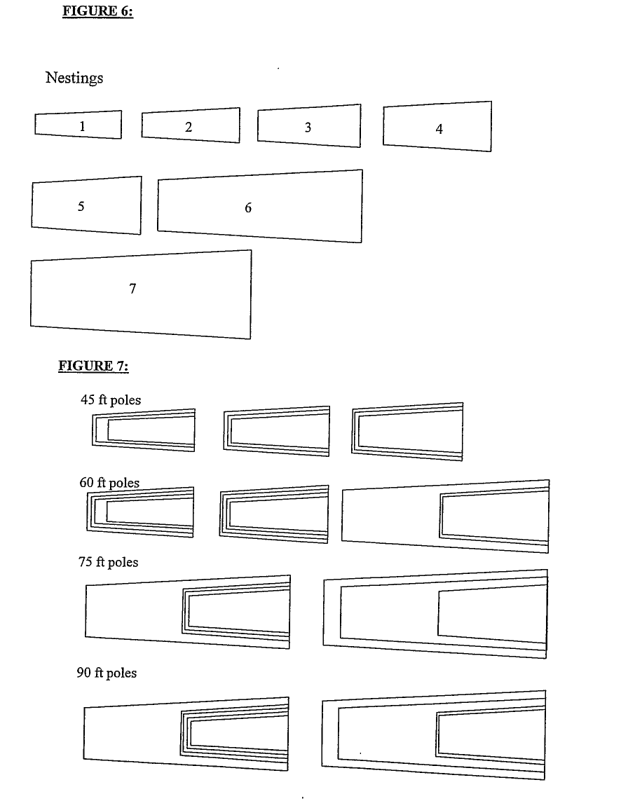

The composite modules of the present invention may be designed so that a smaller module for example but not limited to module 1, 2, 3, 4 of FIG. 6, fits inside a larger module for example but not limited to module 5, 6, 7 (FIG. 6), as shown in FIG. 7. This offers tremendous advantages when handling and transporting modules due not only to the compactness and space saving, but also to the significantly reduced weight when compared to wood, steel or concrete. Modules can be nested together in small stacks. For example, modules 1, 2 and 3 can be nested together which when assembled will form a 45 ft pole like structure with the strength characteristics as indicated in FIG. 2. Similarly modules 2, 3 and 4 can be nested together for transportation. When erected this will form a 45 ft pole like structure with higher strength characteristics as shown in FIG. 2. The modules required to stack together to form a 90 ft pole class 2 pole, can be subdivided to form other constructions. In the example of 90 ft class 2 pole, five modules are required (modules 2, 3, 4, 5 and 6). From this set of modules further structures can be assembled. For example, modules 2, 3 and 4 can be stacked to form a 45 ft class 1 or 2 pole. Modules 3, 4 and 5 can be stacked to form a 45 ft class H1 or H2 pole (see FIG. 2). Modules 5 and 6 can be stacked to form a 45 ft class H3 or H4 pole. Similarly, modules 2, 3, 4 and 5 can be assembled to form a 60 ft pole like structure with the strength capabilities corresponding to class 1 or 2. Modules 4, 5 and 6 can also be assembled to produce a 60 ft pole like structure with a strength capability corresponding to H1 or H2 class. These are shown in FIG. 3. In the same way, modules 3, 4, 5 and 6 can be stacked to form a 75 ft pole like structure with a strength capability corresponding to class 1 or H1.

In essence, a stack of 7 modules has the capability of being erected in many ways. In this embodiment with just 7 modules, 19 variations of pole like structures can be assembled in heights from 30 ft to 90 ft and displaying a variety of strength and stiffness properties. It must be emphasized that this embodiment has used 30 ft-90 ft structures for illustration purposes constructed from 15 ft and 30 ft modules. The system is not limited to a minimum of 30 ft or indeed a maximum of 90 ft or 7 modules. The size of the modules are also not limited to those shown for illustration purposes. The complete system in either part or whole allows for flexibility and ease of erection. If a shorter pole is required, the module may be cut at the desired height. Similarly, if a pole taller than 90 ft is required, then the appropriate composite modules may be designed and matingly fitted together as described herein.

Referring to FIG. 8, a top cap 60 may be placed over top end 54 of an uppermost of the modules, thereby preventing entry of debris or moisture from above. A bottom plug 62 may also be placed into bottom end 52 of a lowermost of the modules, thereby preventing entry of debris or moisture from below. One significant advantage attained from adding a bottom plug is to increase the stability of the foundation and prevent the hollow pole like structure from being depressed into the ground under compressive loading. In many instances a hole 64 is made in bottom plug 62 to allow any moisture from within the stack to drain away.

The present invention will be further illustrated in the following examples. However, it is to be understood that these examples are for illustrative purposes only, and should not be used to limit the scope of the present invention in any manner.

### EXAMPLES

In the Examples that follow all percentages given are percentages by weight unless indicated otherwise.

The following materials were used in the Examples:

POLYISOCYANATE A: A HDI Hexane, 1,6-diisocyanato-, homopolymer polyisocyanate having an NCO content of 23% and a viscosity ranging between 900-1500 cps, which is commercially available from Rhodia under the name Tolonate HDT-LV™
POLYISOCYANATE B: A HDI Hexane, 1,6-diisocyanato-, homopolymer polyisocyanate having an NCO content of 23% and a viscosity ranging between 450-750 cps, which is commercially available from Rhodia under the name Tolonate HDT-LV2™
POLYISOCYANATE C: A mixture of polyisocyanate, polymeric hexamethylene diisocyanate, and less than 5% monomeric 1, 6 Hexamethylene Diidocyanate based Polyisocyanate, having an NCO content of 23% and a viscosity of about 1200 cps, which is commercially available from Bayer material Science LLC under the name of Desmodur N300™.
POLYISOCYANATE D: A polymeric MDI, Polymethylene polyphenyl isocayanate containing 4,4′-Methylene bisphenyl isocyanate, having an NCO content of at least 32% and a viscosity of about 200 cps, which is commercially available from Dow Chemicals under the name of PAPI 27™.
POLYOL A: A polyether polyol having an equivalent weight of about 86 and a functionality of 3.0 which is commercially available from Arch under the name PolyG 76-635™.
POLYOL B: A polyether polyol having an equivalent weight of about 100 and functionality of 4.0 which is commercially available from BASF under the name Pluracol PEP450™
POLYOL C: A polyether polyol having an equivalent weight of about 212 and a functionality of 2.0 which is commercially available from Arch under the name PPG 20-265™
POLYOL D: A polyester polyol having an equivalent weight of about 142 and a functionality of 2.0 which is commercially available from Stephan Company under the name Stepanpol® PS-4002™
POLYOL E: A polyester polyol having an equivalent weight of about 288 and a functionality of about 2.0 which is commercially available from Stephan Company under the name Stepanpol® PS20-200A™
CATALYST A: A tin catalyst which is commercially available from Goldschmidt Industrial Chemicals under the name Tegokat 218™
CHAIN EXTENDER A: 1,4 Butanediol, available from BASF.
UV SYSTEM A: A liquid light stabilizer system comprising a synergistic blend of a light stabilizer, a light absorber and an antioxidant, commercially available from CIBA under the name Tinuvin B75™
UV SYSTEM B: A blend of a liquid hindered light stabilizer commercially available from CIBA under the name Tinuvin 765™ and a liquid benzotriazole light absorber commercially available from CIBA under the name Tinuvin 571™
COLOUR A: Grey colorant commercially available from POLYONE under the name STANTONE HCC™ Gray
COLOUR B: Blend of 50% by weight of COLOUR A with the remainder comprising a 1:1 ratio mixture of Rebus Dark grey 2180™ (available from REBUS) and Colormatch Metal LDR™ (available from Plasticolor).
COLOUR C: Brown colorant commercially available from POLYONE under the name STANTONE HCC™ Brown
MOLECULAR SIEVE A: Purmol 3ST™ (available from ZEOCHEM)
REINFORCEMENT A: Glass fibers commercially available from FGI under the name FLEXISTRAND 250 LYPP 700™

### Aliphatic Isocyanate Polyurethane Resin Composition A

An aliphatic isocyanate polyurethane resin composition (composition A) was made up by mixing polyol component A and POLYISOCYANATE C in a weight ratio of 1:1.7, wherein polyol component A had the following composition:

### Polyol Component A:

79 parts by weight of POLYOL B
15 parts by weight of POLYOL C
3 parts by weight of MOLECULAR SIEVE A
2 parts by weight of COLOR B
1 part by weight of UV SYSTEM A
0.2 parts by weight CATALYST A
Total: 100 parts

Resin composition A had a pot life of about 65 minutes when started at 25° C. and gave a 15 minute working time when started at 40° C. However, by adjusting the catalyst level, the pot life could be adjusted between 5 minutes to 3 hours.

### Aliphatic Isocyanate Polyurethane Resin Composition B

An aliphatic isocyanate polyurethane resin composition (composition B) was made up by mixing polyol component B and POLYISOCYANATE B in a weight ratio of 1:2.44, wherein polyol component B had the following composition:

### Polyol Component B:

65 parts by weight of POLYOL A
18 parts by weight of CHAIN EXTENDER A
11 parts by weight of POLYOL D
2 parts by weight of COLOR A
3 parts by weight of MOLECULAR SIEVE A
1 part by weight of UV SYSTEM B
0.2 parts by weight of CATALYST A
Total: 100 parts

Composition B had a pot life of about 50 minutes when started at 25° C. However, it will be evident to a person skilled in the art that the composition may be modified and refined in various ways.

### Aliphatic Isocyanate Polyurethane Resin Composition C

An aliphatic isocyanate polyurethane resin composition (composition C) was made up by mixing polyol component C and POLYISOCYANATE A in a weight ratio of 1:1.72, wherein polyol component C had the following composition:

Polyol component C
65 parts by weight of POLYOL A
18 parts by weight of POLYOL C
11 parts by weight of POLYOL E
2 parts by weight of COLOR C
3 parts by weight of MOLECULAR SIEVE A
1 part by weight of UV SYSTEM B
0.2 parts by weight of CATALYST A
Total: 100 parts

Composition C had a pot life of about 50 minutes when started at 25C. However, it will be evident to a person skilled in the art that the pot life may be modified and refined in various ways by adjusting the amount of catalyst.

### Manufacture and Testing of Aliphatic Isocyanate Composite Material

Resin Composition C was used to Produce an Aliphatic Isocyanate Composite material. About 75% REINFORCEMENT A was impregnated with about 25% resin composition C and wound onto a mandrel using a filament winding process substantially as hereinbefore described in more detail. The resin impregnated fibers were allowed to cure to hardness and the resulting aliphatic isocyanate composite material had the following properties:

| | |
|---|---|
| Glass fibre content | 75% |
| Specific gravity | 2.0 |
| Interlaminar Shear Strength (ASTM D 2344⁴) | 6500 psi |

⁴ASTM D 2344 is the standard test method for short-beam strength of polymer matrix composite materials and their laminates

Interlaminar Shear Strength test is a good indicator of the quality of the fiber-resin interfacial bond, and hence the quality of the composite material.

### Abrasion Resistance Testing of Aliphatic Top Layered Composite Poles

Aliphatic top layered composite poles having 9 inner layers of an aromatic isocyanate resin composite material and 3 outer layers of an aliphatic isocyanate resin composite material were produced using filament winding process substantially as hereinbefore described in more detail.

The aromatic isocyanate resin composite material inner layers comprised about 70% by weight REINFORCEMENT A impregnated with about 30% by weight aromatic isocyanate polyurethane resin composition A. Aromatic isocyanate polyurethane resin composition A was made by mixing polyol component D with POLYISOCYANATE D in a ratio of 1:1.15, wherein polyol component D had the following composition:

### Polyol Component D:

60 parts by weight of POLYOL A
20 parts by weight of POLYOL C
17 parts by weight of POLYOL E
3 parts by weight of MOLECULAR SIEVE A
0.02 parts CATALYST A
Total: 100 parts

Aromatic isocyanate polyurethane resin composition A had a pot life of about 36 minutes when started at 25C. However, it will be evident to a person skilled in the art that the pot life may be modified and refined in various ways by adjusting the amount of catalyst.

The aliphatic isocyanate resin composite material outer layers comprised about 70% by weight REINFORCEMENT A impregnated with about 30% by weight aliphatic isocyanate polyurethane resin composition C.

The aliphatic top layered composite poles were subjected to blown sand testing using equipment designed for military applications in harsh climates. The United States Military Environmental Testing Specification, blowing sand test MIL-STD-810, was performed by Dayton T. Brown (NY) Laboratories, USA using the following test conditions:

Test Conditions

| | | |
|---|---|---|
| Air Speed | 80 km/h | (50 mph) |
| Temperature | 60° C. | (140° F.) |
| Relative Humidity | <2% | |
| Sand Concentration | 2.15 g/m3 | |
| Test duration | 90 minutes | |

The aliphatic top layered composite poles exposed to the blown sand testing were dulled, but showed no indication of abrasion wear. Minute particles of sand were lodged in the surface causing slight discoloration on the surface. Light buffing of the surface recovered some of the gloss and returned the surface to its original colour. Table 1 shows a comparison of properties of the pole samples before and after the test.

TABLE 1
Properties of aliphatic top-layered composite pole samples before and
after blowing sand test.

| | Flexural | | Flexural | | Interlaminar | |
|---|---|---|---|---|---|---|
| | Strength³ | | Modulus³ | | Shear | |
| | (MPa) | | (GPa) | | Strength⁴ (MPa) | |
| | Actual | StDev | Actual | StDev | Actual | StDev |
| Before Test | 435 | 43 | 13.5 | 0.9 | 39.9 | 2.9 |
| After Test | 428 | 67 | 14.0 | 1.5 | 41.5 | 1.1 |

³Tested using ASTM D 790 which is the standard test method for flexural properties of plastics
⁴Tested using ASTM D 2344 which is the standard test method for short-beam strength of polymer matrix composite materials and their laminates

These results indicate that there was no degradation of physical and mechanical properties in the tested aliphatic top-layered composite pole samples. A post-test visual inspection of the aliphatic top layered pole samples revealed no indication of abrasion except slight dulling of the exposed surfaces. Light buffing of the exposed surface recovered some of its original gloss. The Interlaminar Shear Strength test results indicated that there was good bonding between the fiber-resin interfacial bond and hence the quality of the composite material.

### UV Resistance Testing of Aliphatic Top Layered Composite Poles

Aliphatic top layered composite poles were produced as previously described. UV exposure test, ASTM G154, was performed by Q-Lab Weathering Research Service in Florida, USA. The poles were exposed to UV light for 4088 hours using a lamp setting of 0.77 W/m². Table 2 shows a comparison of properties of the pole samples before and after the test, observed by Q-Lab Weathering Research Service.

TABLE 2
Comparison of visual appearance and mechanical properties of
aliphatic top layered pole before and after UV exposure

| | Non-exposed sample | Exposed sample |
|---|---|---|
| Property | (pre-test) | (post-test) |
| Chalk⁵ | 10 | 10 |
| Flake⁵ | 10 | 10 |
| Blister⁵ | 10 | 10 |
| Crack⁵ | 10 | 10 |
| Check⁵ | 10 | 10 |
| Interlaminar shear strength | 40.1 | 41.5 |
| (ASTM D2344M⁴), MPa | | |
| Flexural modulus | 16.7 | 18.8 |
| (ASTM D790³), Gpa | | |
| Flexural Strength | 593 | 584 |
| (ASTM D790³), Mpa | | |

³ASTM D 790 is the standard test method for flexural properties of plastics
⁴ASTM D 2344 is the standard test method for short-beam strength of polymer matrix composite materials and their laminates
⁵The “visual inspection report” from Q-Lab rated appearance of the composite pole out of ten, with ten being excellent condition indicating no change which is equivalent to zero of ISO.

The visual inspection report from Q-lab indicates that there was no change in appearance of the aliphatic top layered pole following prolonged UV exposure. These results also indicate that there was no degradation of physical and mechanical properties in the tested aliphatic top-layered composite pole samples following prolonged UV exposure.

All references are herein incorporated by reference.

In his patent document, the word “comprising” is used in its non-limiting sense to mean that items following the word are included, but items not specifically mentioned are not excluded, in other words the term “comprising” is substantially equivalent to the phrase “including but not limited to”, and the word “comprises” has a corresponding meaning. A reference to an element by the indefinite article “a” does not exclude the possibility that more than one of the element is present, unless the context clearly requires that there be one and only one of the elements.

The present invention has been described with regard to preferred embodiments. However, it will be obvious to persons skilled in the art that a number of variations and modifications can be made without departing from the scope of the invention as described herein. Citation of references is not an admission that such references are prior art to the present invention.

What is claimed is:

1. A composite article comprising:
an inner core comprising a first composite material; and
one or more than one outer layers comprising a second composite material overlaying the inner core, the second composite material comprising an aliphatic isocyanate polyurethane;
wherein the concentration of aliphatic isocyanate in the second composite material is greater than the concentration of aliphatic isocyanate in the first composite material.

2. The composite article of claim 1, wherein the first composite material comprises a reinforcement impregnated with an aromatic isocyanate polyurethane, the aromatic isocyanate polyurethane comprising from about 20 to about 80% by weight of an aromatic polyisocyanate and from about 20 to about 80% by weight of a first polyol, and the aliphatic isocyanate polyurethane of the second composite material comprises from about 20 to about 80% by weight of an aliphatic polyisocyanate and from about 20 to about 80% by weight of a second polyol.

3. The composite article of claim 1, wherein the composite article is a multi-layered filament wound composite article.

4. A composite module comprising:
an inner core comprising a first composite material; and
one or more than one outer layers comprising a second composite material overlaying the inner core, the second composite material comprising an aliphatic isocyanate polyurethane;
wherein the concentration of aliphatic isocyanate in the second composite material is greater than the concentration of aliphatic isocyanate in the first composite material;
and the composite module comprises a hollow tapered tubular pole section having an open first end and an opposed second end, the diameter of the second end being less than the diameter of the first end, such that the first end of one module mates with the second end of another module to a predetermined length to provide a modular pole assembly.

5. The composite module of claim 4, wherein the first composite material comprises a reinforcement impregnated with an aromatic isocyanate polyurethane, the aromatic isocyanate polyurethane comprising from about 20 to about 80% by weight of an aromatic polyisocyanate and from about 20 to about 80% by weight of a first polyol, and the aliphatic isocyanate polyurethane of the second composite material comprises from about 20 to about 80% by weight of an aliphatic polyisocyanate and from about 20 to about 80% by weight of a second polyol.

6. A modular pole assembly comprising two or more than two composite modules of claim 4, matingly engaged to form a vertical structure of selected height, wherein the first end of an overlying module is mated with the second end of an underlying module.

7. A method of manufacturing a composite article comprising:
providing a core comprising a reinforcement impregnated with a first resin;
mixing an aliphatic isocyanate component and a polyol component to produce a reaction mixture;
impregnating a second reinforcement with the reaction mixture to produce an impregnated reinforcement;
applying the impregnated reinforcement over an outside surface of the core; and
allowing the reaction mixture to set to produce a composite article with one or more than one outer layers of aliphatic isocyanate composite material;
wherein the concentration of aliphatic isocyanate in the reaction mixture is greater than the concentration of aliphatic isocyanate in the first resin.

8. The method of claim 7, wherein the first resin comprises from about 20 to about 80% by weight of an aromatic polyisocyanate and from about 20 to about 80% by weight of a first polyol, and the reaction mixture comprises from about 20 to about 80% by weight of an aliphatic polyisocyanate and from about 20 to about 80% by weight of a second polyol.

9. The method of claim 8, wherein the aliphatic polyisocyanate comprises hexamethylene diisocyanate (HDI), isophorone diisocyanate (IPDI) or a mixture thereof.

10. The method of claim 9, wherein the aliphatic polyisocyanate comprises a mixture of aliphatic hexane 1,6-diisocyanato-homopolymer and hexamethylene diisocyanate (HDI).

11. The method of claim 7, wherein the first or second polyol comprises from about 60 to about 100% by weight of a polyether polyol and from about 0 to about 40% by weight of a polyester polyol

12. The method of claim 11, wherein the polyether polyol has an equivalent weight in the range from about 70 to about 2500 and an hydroxyl functionality equal to or greater than about 2.

13. The method of claim 11, wherein the polyether polyol has an equivalent weight in the range from about 70 to about 400 and an hydroxyl functionality in the range from about 2 to about 6.

14. The method claim 11, wherein the polyester polyol has an equivalent weight in the range from about 70 to about 1000 and an hydroxyl functionality equal to or greater than about 2.

15. The method of claim 11, wherein the polyester polyol has an equivalent weight in the range from about 100 to about 300 and an hydroxyl functionality in the range from about 2 to about 6.

16. The method of claim 7, wherein the reaction mixture further comprises a catalyst selected from the group consisting of tin, bismuth, zinc, titanium and a mixture thereof.

17. The method of claim 7, wherein in the step of applying, the impregnated reinforcement is applied using a process selected from the group consisting of filament winding and pultrusion.

18. A method of manufacturing a multi-layered filament wound composite article comprising:
providing a core comprising reinforcement impregnated with a first resin;
mixing an aliphatic isocyanate component and a polyol component to produce a reaction mixture;
impregnating a fibrous reinforcement with the reaction mixture to produce an impregnated fibrous reinforcement;
winding the impregnated fibrous reinforcement around an outside surface of the core to form a shaped article; and
allowing the reaction mixture to set to produce a multi-layered filament wound composite article with one or more than one outer layers of aliphatic isocyanate composite material;
wherein the concentration of aliphatic isocyanate in the reaction mixture is greater than the concentration of aliphatic isocyanate in the first resin.

19. A method of manufacturing a multi-layered filament wound composite article comprising:
impregnating a fibrous reinforcement with a first resin to produce an impregnated fibrous reinforcement;
winding the impregnated fibrous reinforcement around an outside surface of a mandrel to form a shaped core;
mixing an aliphatic isocyanate component and a polyol component to produce a reaction mixture;
impregnating a second fibrous reinforcement with the reaction mixture to produce an second impregnated fibrous reinforcement;
winding the second impregnated fibrous reinforcement around an outside surface of the core to form a shaped article; and
allowing the reaction mixture to set to produce a multi-layered filament wound composite article with one or more outer layer of aliphatic isocyanate composite material;
wherein the concentration of aliphatic isocyanate in the reaction mixture is greater than the concentration of aliphatic isocyanate in the first resin.
